(19) United States
(12) Patent Application Publication
(10) Pub. No.: US 2005/0111928 A1
(43) Pub. Date: May 26, 2005

(54) Cutting tool

(76) Inventors: Arne Stanarius, Bad Tolz (DE); Christopher Jones, New Orleans, LA (US)

Correspondence Address: THOMAS S. KEATY;KEATY PROFESSIONAL LAW CORP., 2140 WORLD TRADE CENTER, NO. 2 CANAL STREET, NEW ORLEANS, LA, 70130, US

(21) Appl. No.: 10/718,106

(22) Filed: Nov. 20, 2003

(51) Int. Cl. B23C 1/00; B23C 5/20

(52) U.S. Cl. 409/132; 407/113

(57) ABSTRACT

A cutting tool for a milling, drilling or turning machine has a body with a plurality of sides and a central opening. Each side has a perimeter along which cutting planes or edges are formed. Each side has at least two such cutting planes or edges. The planes may have a straight or curved profile, or a combination of straight and curved profiles along one side. The tool may have a plurality of such cutting planes formed along each side of the tool body. The cutting planes may be located at different levels in relation to each other, entering a work piece in sequence, or may be aligned to enter the work piece simultaneously. Preferably, the cutting planes are staggered in two directions—in a feeding direction and in a cutting direction. By dividing each surface being cut into a plurality of segments, the cutting tool creates a plurality of distinct shavings, or splinters that have shorter length in comparison with conventional splinters formed by indexable tips. Shorter cuts require less cutting force, which saves wear on the cutting tool and the machine. At the same time, the cuts can be made deeper and smoother when dividing the cutting surface into a plurality of segments.

### BACKGROUND OF THE INVENTION

The present invention relates to a metal-cutting or milling tool. Such tools are extensively used in the metal working technology for cutting, polishing and creating grooves in a metal work piece.

Conventional milling tools comprise a body rotatable around a central axis; the body being provided with a cutter head that has one or more cutting blades, or cutting tips. As the cutting tips shave or cut off layers of metal, splinters or shavings are created. In conventionally used cutter head designs, the created shavings are long, curled splinters that tend to clog the cutting area as the machine is driving the cutting head.

Milling, drilling or turning machines provide for a rotating cutting tool. In some cases, a work piece being cut is rotated. The term “indexable tip” designates a cutting tool for milling, drilling or turning metal. Indexable tips are conventionally clamped in tool holders, such milling heads or drilling heads. The tool holder, in turn, is clamped to a milling machine. Indexable tips are used in a variety of fields; they are replaced once they become worn. In recent years, the technology was developing in the designs for different covers for the indexable tips.

One of the conventional designs is shown in East German Patent Number 748,294. The German patent discloses the use of a holder with a plurality of indexable tips that provides two edges for cutting the work piece at the same time. The patent suggests that smaller splinters allow reducing the cutting pressure from the cutter head. One of the edges works as a rough machine edge while the second tip works as a smoothing tip. However, one side of the cutting tool in accordance with the German patent performs a single cut.

The German patent was an improvement over even older systems where only one cutting edge was applied for milling or turning metal. With one edge cut, the milling machine had to control the speed of cutting to avoid cluttering and to prevent excessive wear on the milling tool. The tool edge cutting was an improvement over older designs, but still was limited in its basic capacity to reduce the force necessary for creating certain cutting profiles. By using a cutting tool that has one cutting edge, one cannot raise the speed of operation without creating clatter, adversely affecting the quality of the cut surface and wearing the tips and the milling machine much faster.

The present invention contemplates elimination of drawbacks associated with the prior art and provision of a milling tool with indexable tips, or cutting bodies that can create smaller splinters, thus avoiding jamming of the cutting area, while at the same time allowing to create deeper cuts with less stress on the rotating tool.

### SUMMARY OF THE INVENTION

It is, therefore, an object of the present invention to provide a milling tool with indexable tips that creates at least two splinters with each quarter-turn revolution of the milling head.

It is another object of the present invention to provide a milling tool that requires less force for running the cutter head while performing the required cuts in a work piece.

It is a further object of the present invention to provide a milling tool that includes indexable tips of different geometric profiles, depending on the type of processing and cutting needs.

These and other objects of the present invention are achieved through a provision of a cutting tool that has a body adapted for operationally connecting to a rotating shaft of a cutting, milling, or turning machine. The body has a plurality of sides, with each side comprising at least two cutting planes. Each cutting plane or edge has its own tool-referring system. The cutting edges are staggered in two directions—in feeding direction and also in cutting direction. In contrast, prior designs had the cutting edges staggered only in one direction—feeding direction.

When the body engages a work piece and is rotated, at least two splinters are formed with each quarter-turn of the milling head. The cutting planes are separated by a connecting plane that does not perform the cut but facilitates creation of a plurality of shorter distinct splinters. The splinters have different cutting depth allowing creation of a smooth, even cut. The splinters have an optimized profile, with a better proportion between the width and the length that is possible with conventional cutting tools.

The cutting planes may have straight or curved profile, or comprise a combination of straight and curved profiled planes. The cutting planes are defined by four edges: a first edge, a second edge that extends in parallel relationship to the first edge, a third edge that extends at an angle between the first and the second edges and a fourth edge that extends between the first edge and the second edge in a non-parallel relationship to the third edge.

By forming shorter splinters with each cutting plane, the tool of the present invention allows elimination of clogging or jamming of a cutting or milling machine, reduces wear on the cutting machine, while performing the same depth cuts, eliminates vibration or clatter and create a deeper cut than is possible with conventional indexable tips.

### BRIEF DESCRIPTION OF THE DRAWINGS

Reference will now be made to the drawings, wherein like parts are designated by like numerals and wherein

FIG. 1 is a perspective view of the first embodiment of a cutting body in accordance with the present invention.

FIG. 2 is a front view of the first embodiment of the present invention showing the cutting edges creating a cut in a work piece.

FIG. 3 is a detail view showing cutting edges contacting the work piece in the embodiment of FIGS. 1-2.

FIG. 4 is a front view of the first embodiment of the cutting tool, similar to the view of FIG. 3, wherein the relief angle of the minor cutting edge is greater than 0 degrees in comparison with the view of FIG. 2.

FIG. 5 is a detail view showing cutting edges for the position of the cutting planes of the first embodiment wherein the relief angle of the minor cutting edge is greater than 0 degrees.

FIG. 6 is a perspective view of the second embodiment of the cutting tool in accordance with the present invention illustrating a plurality of squared cutting edges formed along each side of the cutting body.

FIG. 7 is a top view of the cutting body of the second embodiment of the present invention.

FIG. 8 is a schematic view illustrating position of the cutting body of the second embodiment engaging a work piece being cut.

FIG. 9 is a side view of one side of the cutting body according to the second embodiment of the present invention engaging a work piece.

FIG. 10 is a front view of the cutting body of the second embodiment of the present invention showing cutting edges created by stepped-up cutting modules, or blocks.

FIG. 11 is a schematic view showing the cutting body engaging a work piece when moving in the direction shown in FIG. 10.

FIG. 12 is a schematic view of the cutting body of the present invention showing direction of forces applied by multiple cutting planes on a work piece.

FIG. 13 is a schematic view showing a plurality of angles formed by stepped-up planes and surfaces of each side of the cutting body.

FIG. 14 is a schematic view showing the cutting tool of FIG. 12 engaging a work piece taken in the direction of movement shown by the arrow.

FIG. 15 is a schematic view of the third embodiment of the cutting tool in accordance with the present invention showing a plurality of splinters created along one side of the tool.

FIG. 16 is a detail view of the cutting edges creating multiple-length splinters along one side of the cutting tool.

FIG. 17 is a schematic view of the tool of the third embodiment of the cutting tool of the present invention, wherein the relief angle of the minor cutting edge is greater than 0 degrees.

FIG. 18 is a detail view, similar to the view of FIG. 16, showing the relief angle of the minor cutting edge greater than 0 degrees.

FIG. 19 is a side view of an indexable tip, where the top surface of the cutting body is formed concave.

### DETAILED DESCRIPTION OF THE PREFERRED EMBODIMENT

Turning now to the drawings in more detail, numeral 10 designates a cutting tool body in accordance with the first embodiment of the present invention. The cutting tool, or indexable tip body 10, is formed as an irregularly-shaped body. The cutting body is a solid body with four sides and eight cutting planes designated by numerals 14, 16, 18, 20, 22, 24, 26, and 28. The planes 14, 18, 22, and 26 are flat surfaces which are integrally connected to the adjacent rounded planes 6, 20, 24, and 28 by inclined connecting surfaces 30, 32, 34, and 36.

The cutting body 10 has a top, generally flat surface 40 and a bottom, generally flat surface 42. The surfaces 40 and 42 provide vertical limits to the extension of the cutting planes 14, 16, 18, 20, 22, 24, 26, and 28. In operation, the tip 10 is clamped on a milling head in a conventional manner, and the central opening 12 facilitates this step.

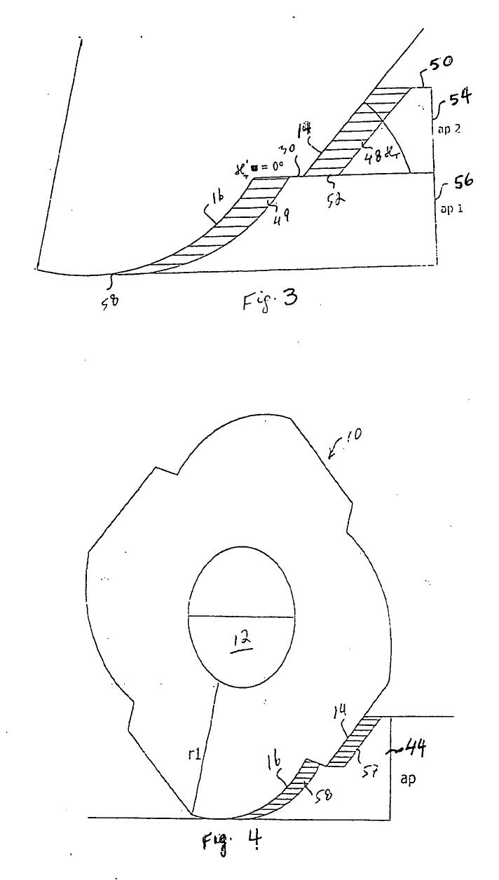

As shown in FIGS. 2 and 3, a work piece 44 is being cut by the cutting planes of the cutting body 10. The contact between the body 10 and the work piece 44 is made along the interface of a straight cutting plane 14 and a rounded, or arcuate cutting edge 16. The work piece 44 has a defined vertical dimension “ap,” as shown in FIG. 2 and designated by the dimensional line 46. When a conventional cutting tool is used, a splinter created by a cutting member is equal to the vertical dimension “ap” of the work piece 44. In contrast, the cutting tool of the present invention, having divided the contact cutting surface into two distinct lengths, creates two splinters, a first splinter 48 and a second splinter 49, at each quarter-turn of the milling head.

The combined length of the splinters 48 and 49 is limited by the radius “r1” of the cutting body 10. As shown in FIG. 3, the vertical dimension or the length of the first splinter 48, is limited by the length of the cutting plane 14; it extends from the top surface 50 of the work piece 44 to the end 52 of the cutting plane 14, wherein the inclined connecting surface 30 terminates the extension of the cutting plane 14. The length “ap2” of the first splinter 48 is designated by numeral 54 in FIG. 3, while the length “ap1” of the second splinter, formed by the rounded plane 16 is designated by numeral 56 in FIG. 3.

The second splinter 49 extends from the edge of the connecting plane 30 to an end 58 of the cutting plane 16. The relative length of the splinters 48 and 49 can be varied, depending on the length of the connecting planes 14 and 16 formed along one side of the cutting body 10. It will be appreciated that the same result is achieved when the mill head is turned a quarter of a turn, moving the cutting edges 28 and 26 into contact with the work piece 44.

Another quarter of a turn of the milling head will place the cutting surfaces 22 and 24 in contact with the work piece 44. A final quarter of a turn will cause the cutting surfaces 18 and 20 into contact with the work piece 44. As the milling head rotates, the work piece 44 is gradually milled or cut in a desired pattern, creating same depth, or width splinters as the cutting tool progresses.

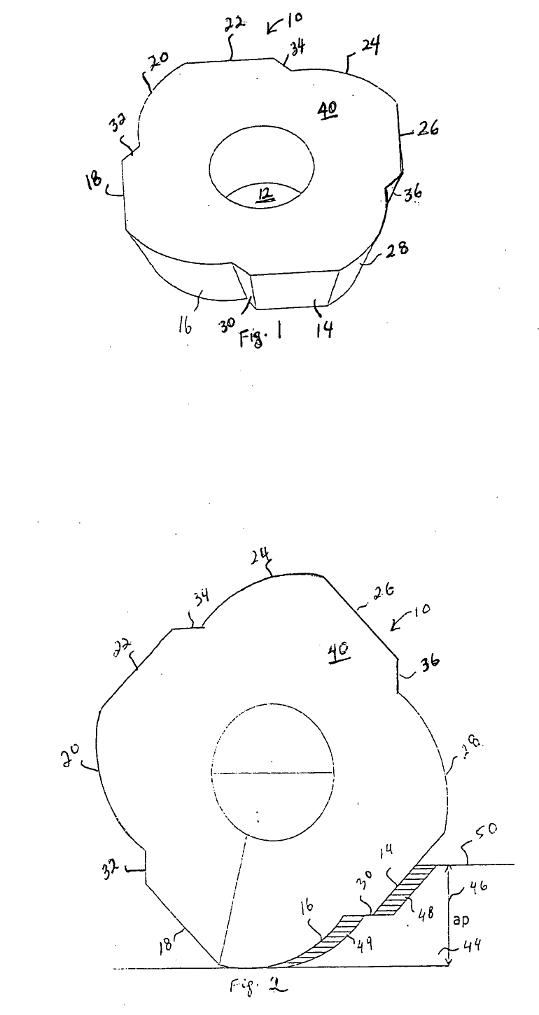

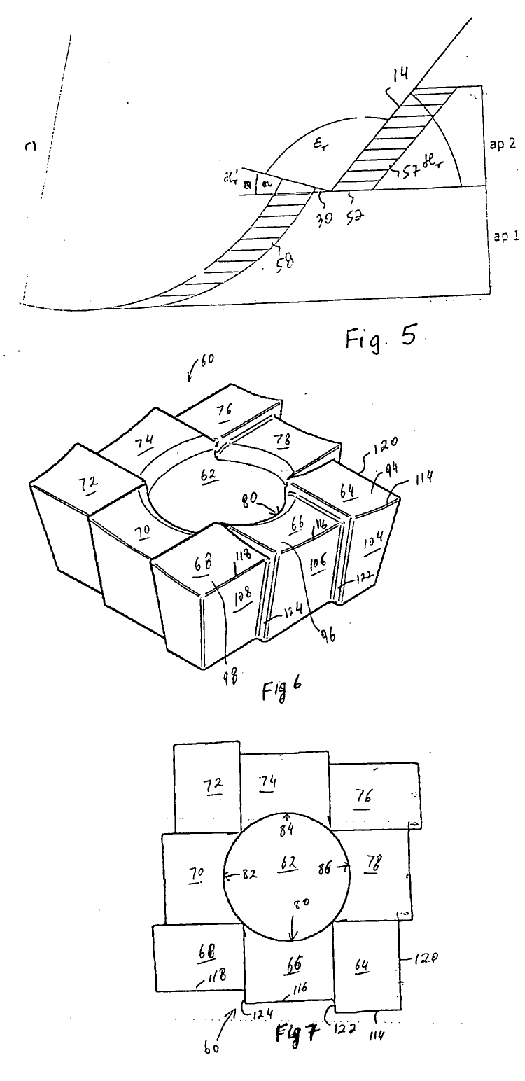

The profile and the length of the splinters can be affected by inclining the axis of the rotation of the cutting body 10. As shown in FIGS. 4 and 5, the rotating body 10 is inclined 15 degrees to contact the work piece 44 at a different angle in comparison with the angle shown in FIGS. 1-3. Of course, any relief angle of the minor cutting edge greater than “0” degrees may be used for the illustration. In FIGS. 4 and 5, the connecting plane 30 forms an angle “a” in relation to the edge 52 of the cutting plane 14. With the same radius of the body 10, the splinters 57 and 58 change the profile, cutting deeper into the work piece 44 while the relative lengths of the splinters 57 and 58 is shorter than the length of the splinters 48 and 49, respectively.

Turning now to the second embodiment shown in FIGS. 6-14, the cutting body 60 is shown to have four sides and a central opening 62. The central opening 62, similarly to the opening 12, is adapted to facilitate clamping of the body 60 on a milling head 61 (FIG. 8). Each side of the cutting tool body 60 has three irregularly-shaped blocks that have cutting edges. There are a total of eight blocks 64, 66, 68, 70, 72, 74, 76 and 78, which are attached to each other. Each side 80, 82, 84 and 86 of the body 60 has three blocks.

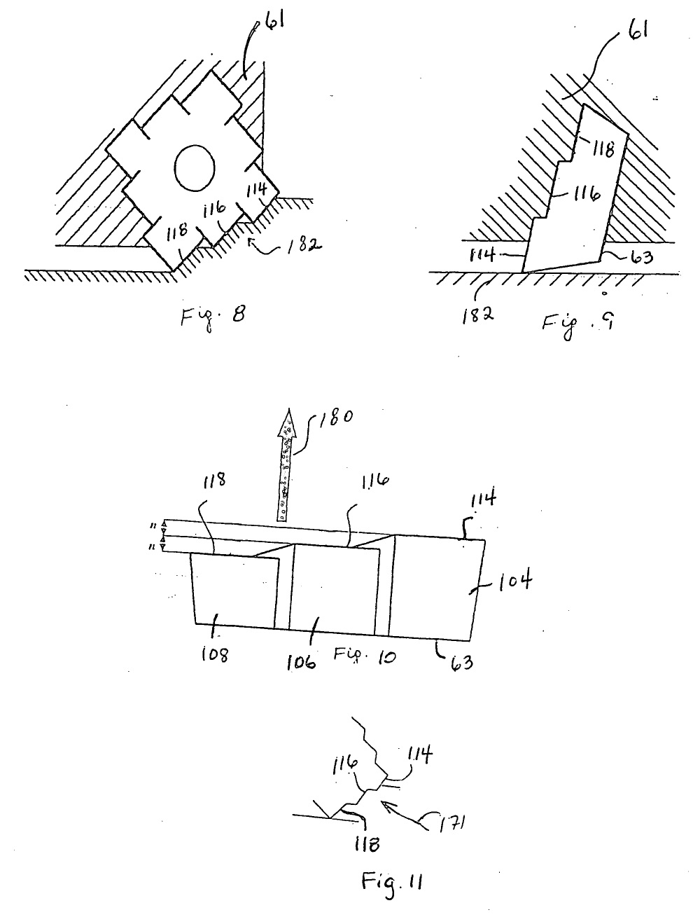

With reference to the side 80, the blocks 64, 66 and 68 have respective staggered top surfaces 94, 96 and 98 and staggered vertical planes 104, 106 and 108. The body 60 has a bottom, non-cutting surface 63 (FIGS. 9 and 10). A line of connection between the vertical surface 104 and the top surface 94 forms a cutting edge 114; the line of connection between the plane 106 and the top surface 96 forms a second cutting edge 116; and the line of connection between the vertical plane 108 and the top surface 98 forms a third cutting edge 118. Similar cutting edges are formed by the blocks 70-78.

It should be noted that the “corner” blocks 64, 68, 72 and 76 have two cutting edges. For instance the block 64 has the cutting edge 114 and a cutting edge 120 that is oriented at about 90 degrees in relation to the edge 114. The same arrangement is repeated for other blocks forming the body 60. As the result of such design, the cutting edges are staggered in two directions—in feeding direction and in cutting direction.

As can be further seen in FIGS. 6 and 7, each block has a portion of a vertical plane extending outwardly in relation to the adjacent block. The outwardly extending portions, such as portions 122 and 124 of the blocks 64 and 66 facilitate an interruption in the length of the created splinter, allowing each side 80, 82, 84 and 86 to form three distinct lengths of splinters.

The cutting plane 114 of the block, or module 64 158 is higher than the cutting plane 116 of the cutting block 66. The cutting plane 118 of the cutting block 68 is lower than the cutting edge 116.

The direction of cutting is shown by an arrow 180 in FIG. 10. A distance “n” is created between the cutting planes 114 and 116. A similar distance “n” is created between the cutting planes 116 and 118. As shown in a side view in FIG. 9, the cutting planes 114, 116, and 118 engage the surface of the work piece 182 at different planes as the cutting tool 60 contacts the work piece 182. In the detail view showing a tool-edge plane in FIG. 10, one can change a tool inclination angle for each cutting plane. This angle may be positive or negative.

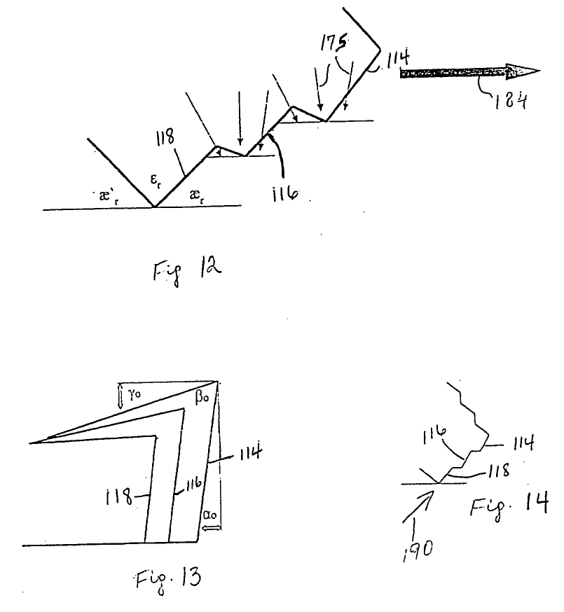

FIG. 11 schematically illustrates the position of the cutting planes or edges 114, 116, and 118 58, 160 and 162 in relation to a work piece when the cutting tool is in operation. The view direction is taken in the direction of arrow 171.

FIG. 8 illustrates position of the indexable tip 60 with one of its sides engaging the work piece 182; this view is taken in the direction of cutting. Here, a substantial portion of the cutting planes 114, 116, and 118 engages the work piece 182 while a certain non-contact surface is created by the connecting planes that do not contact the work piece 182.

FIG. 12 schematically illustrates the forces acting on the work piece by the cutting planes and edges 114, 116, and 118. The direction of the cutting forces is represented by arrows 175 in FIG. 12. The feed rate direction is designated by an arrow 184. In a tool-reference plane, each cutting plane, or edge can have a variable length and profile (straight, rounded, a combination of the two, etc.). Each cutting plane or edge has its own angle æᵣ of contacting the work piece. It is possible to vary the tool corner angle ε_{r.}, and the tool adjusting angle of the secondary edge æ′ᵣ, for each edge.

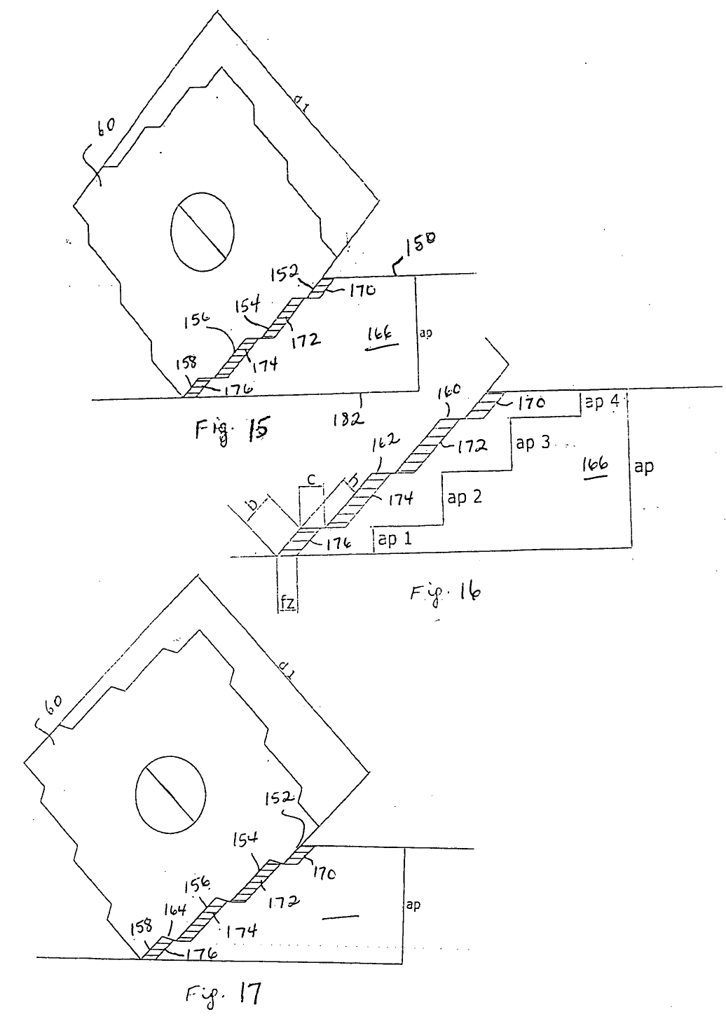

In a tool-orthogonal plane shown in a detail view in FIG. 13, it is possible to vary the free space angle of α, the wedge angle αo, and the splinter-angle γo. FIG. 14 illustrates the direction of viewing the cutting edges 114, 116 and 118 as they engage the work piece, with the view take in the direction of arrow 190.

The lengths of the cutting edges 114, 116 and 118 can be varied in this embodiment of the cutting tool. It should be noted that the edges 114, 116, and 118 may be rounded, squared, or be a combination of straight and curved profiles, as required. FIG. 19 illustrates an embodiment where the cutting edges 134, 136 are formed concave, while the edge 138 is formed straight. The edges 134 and 138 are shorter than the edge 136, and the edge 138 is longer than the edge 134.

Similarly to the first side 80, the sides 82, 84, 86 and 88 are formed with a plurality of cutting edges, which are staggered in relation to each other in two directions—the feeding direction and the cutting direction. Each side has a plurality of distinct cutting edges that form a plurality of splinter segments when the cutting tool 60 engages a work piece 182.

Turning now to the third embodiment of FIGS. 15—18, the cutting body 60 has four sides, each with four cutting edges, such as edges 152, 154, 156 and 158 identified in FIGS. 15-18. The cutting planes, or edges 152, 154, 156 and 158 are connected by inclined connecting planes 160, 162 and 164. The three other sides of the body 60 is similarly provided with four cutting planes, which are connected to adjacent cutting planes by inclined surfaces.

FIG. 15 illustrates position of the body 60 engaging a work piece 166 with four cutting surfaces that form cutting edges along the areas of contact between the body 60 and the work piece 166. In this embodiment, the cutting tool creates four unequal length splinters 170, 172, 174, and 176. The profiles of the splinters differ from a conventional one piece profile that would extend roughly from a top surface 150 to the bottom surface 182 of the work piece 166. As can be better seen in FIG. 16, the length of the splinters can vary, depending on the geometry of the cutting planes 152, 154, 156, and 158. The length of the splinters can be easily modified by forming different length cutting planes along the sides of the cutting body 60.

The splinters created with the cutting surfaces of the body 60 have a predetermined cutting depth designated as “ap1”, “ap2”, “ap3”, and “ap4”. The cutting depth “ap” of each splinter depends on the geometry of the cutting plane. The length of the splinters “b” depends on he length of the cutting plane, by which the splinter is created. Using the same cutting force as the conventional cutting tools, the tool of the present invention is capable of creating deeper, smoother cuts due to forming of multiple cutting planes along each side of the body 60. The feed rate “h” may be same as that used by conventional tools. However, with the tool of the present invention, less cutting force is required for the same cut of the work piece. Additionally, the shorter splinters are easier to remove, they are less prone to clog the working surfaces of the milling or cutting machine.

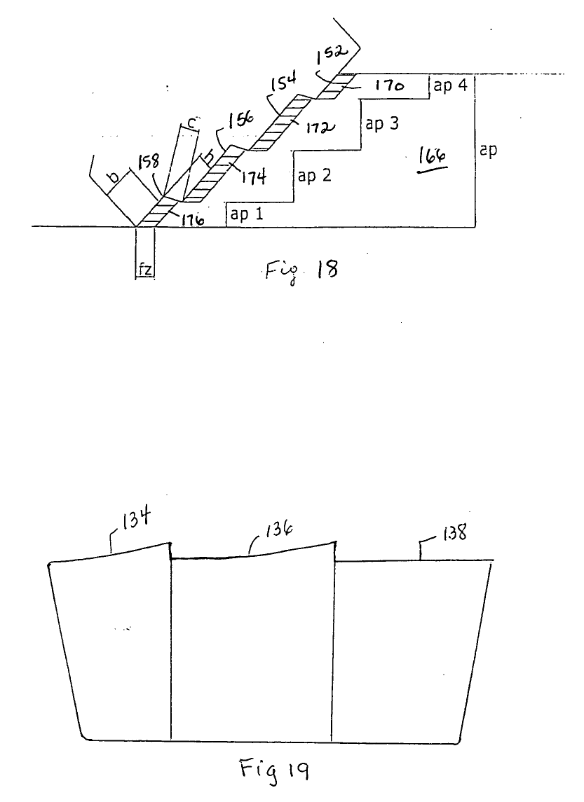

In FIGS. 17 and 18, the third embodiment of the indexable tip of the present invention is shown with the axis of rotation tilted at about 15 degrees in relation to the position of the cutting tool shown in FIGS. 15 and 16. In the views of FIGS. 17 and 18, the profile of the cut splinters 170, 172, 174, and 176 has been changed. Here, the splinters are not as wide, since the contact of the cutting planes with the work piece has been modified. With the inclined axis of rotation, the cutting edges become inclined at a more acute angle in relation to the work piece 166, allowing to achieve a smoother cutting surface, as necessary.

The cutting tool of the present invention, in each of the above-described embodiments, allows to produce more than one splinter along the cutting depth of a work piece. The productivity of the milling or cutting machine using the cutting tool, or indexable tip of the present invention is increased because the cutting and feed forces can be optimized. Smaller splinters are easier to handle; they do not hinder the cutting process by jamming the milling tool and are suitable for automatic splinter removal, via a conventional conveyor belt.

The decreased cutting and feed forces required to perform a pre-determined cut in a work piece are realized throughout an optimized splinter profile. This profile has a better proportion between the width and the length of the splinters. Compared to conventional tools that create one long splinter, which has a length equal to the size of the cut work piece, the tool of the present invention produces a plurality of shorter splinters while achieving a greater cutting depth and smoother cut. When employing the same cutting reaction as used by conventional tools, an operator using the tool of the present invention can achieve higher dynamic stability, which directly translates into a better finished surface and a decreased strain on the milling or cutting machine.

The concept of dividing the length of a surface being cut into a plurality of smaller segments can be used for indexable tips of all forms, such as round, squared or multi-cornered profiles with round or straight edges or combinations thereof. The sizes of the cutting planes and edges can be easily varied when making the cutting tool; the sizes will depend on the types of process and cutting needs (material, feed rate, cutting depth, etc.).

Further advantages of the cutting tool of the present invention is seen in the ability to create a synchronized entrance of the cutting planes, or edges into the working material. Since the cutting planes are arranged around the perimeter of the cutting tool body, the cutting modules defining the cutting planes may be changed when they become worn. The planes may be also inclined to enter the work piece at different times, which reduces the impact force when entering the work piece and renders the cutting process more stable.

The cutting planes and edges may be arranged in their own individual way, varying the angle of the plane, the angle of the plane's orientation in relation to the adjacent planes and to the connecting, non-cutting planes. The planes may be located on different levels, with the distance between the cutting planes modified as the operational demands are met. Of course, the material, from which the cutting tool is manufactured can be easily varied depending on the job to be performed by a particular cutting tool, whether it is cutting aluminum, steel, or other type of metal.

Many other changes and modifications can be made in the cutting tool of the present invention. I, therefore, pray that my rights to the present invention be limited only by the scope of the appended claims.

1. A milling tool, comprising:
a body adapted for mounting on a rotating shaft of a milling machine, said body having a plurality of sides and at least two cutting planes formed on each of said plurality of sides.

2. The tool of claim 1, wherein at least one of said cutting planes has an arcuate contact surface for engaging a work piece being milled.

3. The tool of claim 1, wherein at least one of said cutting planes has a straight contact surface for engaging a work piece being milled.

4. The tool of claim 1, wherein said at least two cutting planes are integrally connected to each other by a connecting plane extending at an angle in relation to at least one of said at least two cutting planes.

5. The tool of claim 1, wherein said at least two cutting planes are integrally connected to each other by a connecting plane extending at an obtuse angle in relation to at least one of said at least two cutting planes.

6. The tool of claim 1, wherein said body comprises a flat top surface and a flat bottom surface, and wherein said sides extend at a right angle between said top surface and said bottom surface.

7. The tool of claim 1, wherein said body comprises a multi-plane top surface and a flat bottom surface, and wherein said sides extend at a right angle to said bottom surface.

8. The tool of claim 7, wherein the cutting planes are staggered in a feeding direction and in a cutting direction.

9. The tool of claim 1, wherein each of said at least two cutting planes is defined by a first edge, a second edge extending in parallel relationship to said first edge, a third edge extending at an angle between said first edge and said second edge, and a fourth edge extending in a non-parallel relationship to said third edge, between said first edge and said second edge.

10. The tool of claim 9, wherein the first edge, the second edge, the third edge and the fourth edge are defined by straight lines.

11. The tool of claim 9, wherein said first edge and said second edge are defined by arcuate lines.

12. A cutting tool, comprising:
a cutting body adapted for mounting on a rotating shaft and capable of being rotated during a process of cutting a work piece, said cutting body having a plurality of sides and at least two cutting planes formed on each of said plurality of sides, and wherein at least one of said cutting planes has an arcuate contact surface for engaging a work piece being milled.

13. The tool of claim 12, wherein said at least two cutting planes are integrally connected to each other by a connecting plane extending at an angle in relation to at least one of said at least two cutting planes.

14. The tool of claim 12, wherein said at least two cutting planes are integrally connected to each other by a connecting plane extending at an obtuse angle in relation to at least one of said at least two cutting planes.

15. The tool of claim 12, wherein said body comprises a flat top surface and a flat bottom surface, and wherein said sides extend at a right angle between said top surface and said bottom surface.

16. The tool of claim 12, wherein each of said at least two cutting planes is defined by a first edge, a second edge extending in parallel relationship to said first edge, a third edge extending at an angle between said first edge and said second edge, and a fourth edge extending in a non-parallel relationship to said third edge, between said first edge and said second edge.

17. The tool of claim 12, wherein the cutting planes are staggered in a feeding direction and in a cutting direction.

18. A method of forming a cut on a work piece, comprising the steps of:
providing a cutting body having a plurality of sides and at least two cutting planes formed on each sides and wherein said cutting planes are staggered in a feeding direction and in a cutting direction;
rotating said cutting body such that the cutting planes contact the work piece, while creating at least two cutting splinters with each quarter-turn revolution of said cutting body.

19. The method of claim 18, further comprising the step of providing a cutting body having a plurality of cutting planes formed on each side of the cutting body, thereby creating a plurality of cutting splinters with each quarter-turn revolution of the cutting body.

20. The method of claim 18, wherein each of said cutting planes is defined by a first edge, a second edge extending in parallel relationship to said first edge, a third edge extending at an angle between said first edge and said second edge, and a fourth edge extending in a non-parallel relationship to said third edge, between said first edge and said second edge.

21. The method of claim 18, wherein at least of said cutting planes has an arcuate cutting edge.

22. The method of claim 18, wherein at least one of said cutting planes has a straight cutting edge.
